(19) United States
(12) Patent Application Publication
(10) Pub. No.: US 2011/0034073 A1
(43) Pub. Date: Feb. 10, 2011

(54) Plug-Type Connection for Making Contact with an Electrical Printed Circuit Board which is Arranged in a Housing

(75) Inventors: Klaus Umfahrer, Stuttgart (DE); Martin Jacobi, Villingen-Schwenningen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/989,223

(22) PCT Filed: Apr. 16, 2009
(86) PCT No.: PCT/EP2009/054512

§ 371 Date: Oct. 22, 2010

(30) Foreign Application Priority Data
Apr. 24, 2008 (DE) 10 2008 020 668.7

(51) Int. Cl. H01R 13/40

(52) U.S. Cl. 439/587

(57) ABSTRACT

A plug-type connection for making contact with a printed circuit board which is arranged in a housing and has a connection which is arranged outside the housing has a support in which contacts are fixedly arranged. The support additionally has sealing edges for sealing off said support from a housing aperture in the housing. The support and the sealing edges are produced by multi-component injection molding. The plug-type connection allows particularly reliable sealing of the housing and is simple to produce.

### PRIORITY CLAIM

This is a U.S. national stage of Application No. PCT/EP2009/054512, filed on Apr. 16, 2009, which claims priority to German Application No: 10 2008 020 668.7, filed: Apr. 24, 2008 the contents of which are incorporated herein by reference.

### BACKGROUND OF THE INVENTION

1. Field of the Invention

The invention relates to a plug-type connection for making contact with an electrical printed circuit board arranged in a housing, having contacts which are routed to outside the housing and a seal for sealing off the contacts from an aperture in the housing.

2. Related Art

Plug-type connections of this kind are often used in devices employed in modern motor vehicles and are known from practice. For long-term functioning of the device, it is necessary to ensure that it is reliably sealed and, in particular, no moisture can enter the device through the housing aperture. In known plug-type connections, a rubber block is usually placed over the contacts. The rubber block then seals off the contacts from the housing aperture. One disadvantage of this plug-type connection is that the rubber block is costly to produce and fit. Furthermore, the rubber block may be forgotten or slip off, with the result that reliable sealing of the housing is no longer ensured.

### SUMMARY OF THE INVENTION

One embodiment of the invention is based on developing a plug-type connection of the kind mentioned in the introduction such that it can be assembled in a particularly simple manner and ensures reliable sealing of the housing.

According to one embodiment of the invention, the contacts are inseparably connected to a support. The support has at least one peripheral sealing edge that bears against the housing aperture. By virtue of this configuration, the contacts are fixedly connected to the support and cannot be separated from said support without being destroyed. The arrangement of the sealing edge on the support ensures that the sealing edge cannot get lost. In addition, a component which needs to be additionally fitted is not required, and therefore the plug-type connection according to one embodiment of the invention can be fitted in a particularly simple manner. By virtue of the support being connected to the contacts, the support, and therefore the sealing edge, cannot slip. Therefore, the plug-type connection provides particularly reliable sealing of the housing.

According to one embodiment of the invention, the support and the sealing edge are produced in a particularly simple manner when the support is produced from an inelastic thermoplastic and the sealing edge is produced from an elastic thermoplastic using an injection molding method. The multi-component injection molding method can be used to jointly produce such a support with the sealing edge. As a result, the support and sealing edge are integrally produced and therefore reliably sealed off from one another. Furthermore, the sealing edge cannot get lost during assembly of the plug-type connection, this contributing to increasing the reliability of the plug-type connection according to the invention against the ingress of moisture into the housing.

According to one embodiment another advantageous development of the invention, the support is sealed off in a structurally simple manner when the housing aperture is in the form of a shaft, and when the sealing edge is arranged radially on the outside of the support.

A contribution is made to further improving the leaktightness of the plug-type connection according to one embodiment of the invention when the sealing edge is arranged axially on that side of the support which is away from the printed circuit board. In this case, the sealing edge can be prestressed against the housing and increase the sealing effect of the sealing edge which is arranged radially on the support. As an alternative , the sealing edge can also serve to seal off a plug arranged on the contacts. The sealing edge arranged axially on that side of the support which is away from the printed circuit board is preferably provided in addition to the sealing edge arranged radially on the outside of the support.

According to one embodiment of the invention, strain relief can be established for the contacts in a simple manner by the housing when the housing aperture has a projection that faces the printed circuit board, and when the support bears against the projection. By virtue of this configuration, tensile forces on the contacts are introduced directly into the housing via the support. A loading on the printed circuit board from outside the housing via the contacts is reliably prevented.

The contacts can also be relieved of strain in the case of housing apertures without a projection when the support has a stop that bears against that side of the housing aperture that faces the printed circuit board.

According to one embodiment of the invention, the contacts can be oriented simply in relation to the printed circuit board in a simple manner when the support is integrally produced with fixing pins that enter recesses in the printed circuit board. The contacts are preferably soldered, pressed, or pressed and soldered to the printed circuit board.

Stresses between the contacts, which are produced from metal, and the support, which is produced from plastic, can lead to leaks. According to one embodiment of the invention, such leaks can be avoided in a simple manner when the contacts are sealed off from the support by means of a sealing compound. Furthermore, the support has a supporting function as a result, while the sealing compound and the sealing edge ensure sealing. This ensures, in addition, that the materials for the support and for the contacts can be freely selected.

According to one embodiment of the invention, the contacts can be reliably connected to the support in a simple manner when the support has tubular stubs that sheath the contacts. The stubs preferably sheath the contacts individually.

### BRIEF DESCRIPTION OF DRAWINGS

The invention permits numerous embodiments. In order to further explain the basic principle of the invention, one of said embodiments is illustrated in the drawings and will be described in the text which follows. In the drawings:

FIG. 1 is a sectional diagram through a plug-type connection according to one embodiment of the invention;

FIG. 2 is shows a side view of the support with contacts of the plug-type connection from FIG. 1;

FIG. 3 is a plug-type connection according to one embodiment of the invention with a projection in a housing aperture; and

FIG. 4 is a plug-type connection with a stop on the support.

### DETAILED DESCRIPTION OF THE DRAWINGS

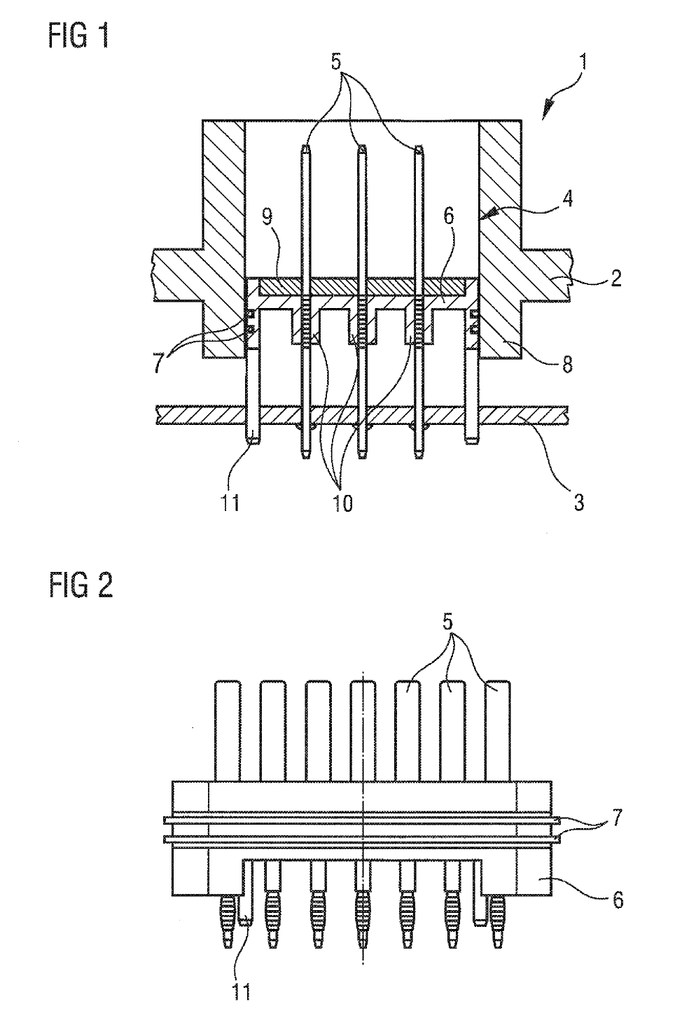

FIG. 1 is a sectional illustration through a plug-type connection 1 of an electrical device having a printed circuit board 3 arranged in a housing 2 and having contacts 5 routed through a housing aperture 4. In each case, one end of the contacts 5 is soldered, pressed or pressed and soldered in the printed circuit board 3, while the other end projects out of the housing 2. A plug (not illustrated) can be attached to that end of the contacts 5 which projects out of the housing 2.

The contacts 5 are inseparably connected to a common support 6 by being pressed in or by encapsulation by molding using an injection molding method. The support 6 has radially outwardly peripheral sealing edges 7. The sealing edges 7 seal off the support 6 from a shaft 8 of the housing aperture 4. A sealing compound 9 seals off the contacts 5 from one another and from the support 6. The support 6 additionally has tubular stubs 10 that sheath the contacts 5 individually.

The support 6 also has fixing pins 11 that enter the printed circuit board 3. These fixing pins 11 serve to align the support 6 during assembly before the contacts 5 are soldered to the printed circuit board 3. After soldering, the printed circuit board 3 is inserted into the housing 2 and the support 6 and the contacts 5 are introduced into the housing aperture 4. In the process, the sealing edges 7 of the support 6 seal off the housing 2.

As shown in FIG. 2, in a side view of the support 6 with the contacts 5 before assembly, the sealing edges 7 are arranged on the support 6, preferably produced by multi-component injection molding.

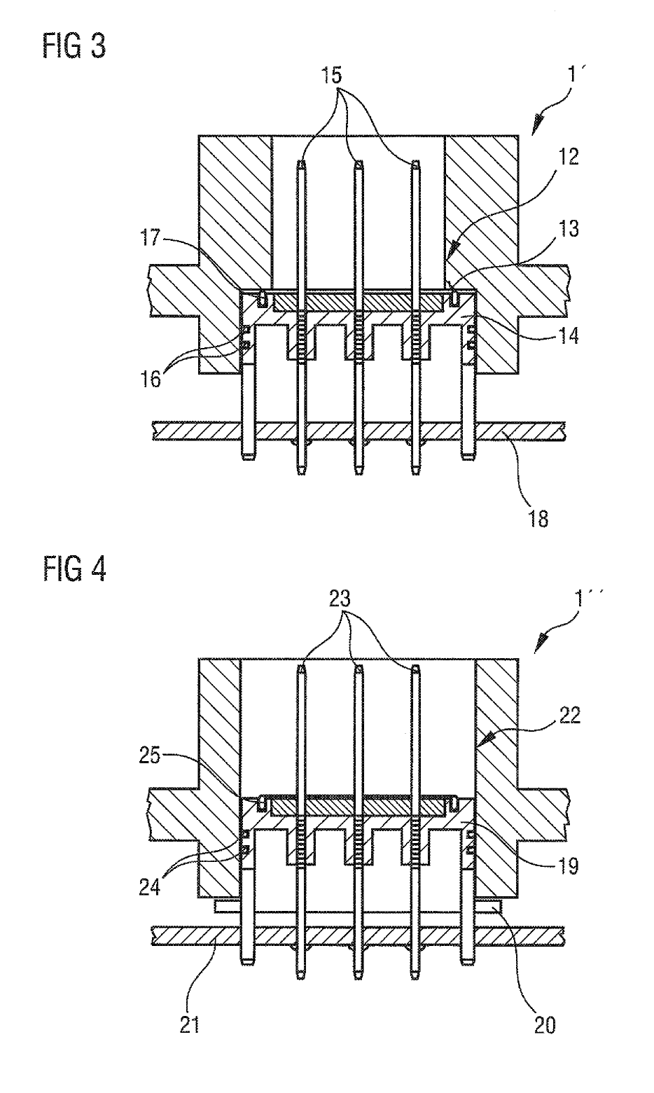

FIG. 3 is a further embodiment of the plug-type connection 1′ which differs from that of FIG. 1 in that a projection 13 is arranged in a housing aperture 12. A support 14 with contacts 15 is situated opposite the projection 13. Furthermore, the support 14 has two radially peripheral sealing edges 16 and additionally one sealing edge 17 which axially points away from a printed circuit board 18. The sealing edge 17 which axially points away from the printed circuit board 18 bears against the projection 13 in the housing aperture 12. Otherwise, this embodiment of the plug-type connection 1′ is has the same design as that of FIGS. 1 and 2.

FIG. 4 is a further embodiment of the plug-type connection 1″ which differs from that of FIG. 1 in that a support 19 is integrally produced with a radially projecting stop 20. The stop 20 is arranged on that side of a housing aperture 22 which faces the printed circuit board 21. The support 19 also has a plurality of contacts 23, two radially peripheral sealing edges 24 for providing sealing from the housing aperture 22 and one sealing edge 25 which axially projects away from the printed circuit board 21. This axially projecting sealing edge 25 serves to seal off the support 19 from a plug (not illustrated) attached to the contacts 23.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A plug-type connection configured to make contact with an electrical printed circuit board, the plug-type connection comprising:
a housing having an aperture therethrough and configured to have the printed circuit board arranged therein;
a support having at least one peripheral sealing edge, the sealing edge configured to bear against the housing aperture;
contacts inseparably connected to the support, the contacts routed to an outside of the housing;
a seal configure to seal off the contacts from the aperture in the housing.

11. The plug-type connection as claimed in claim 10, wherein
the support is an inelastic thermoplastic,
the sealing edge is an elastic thermoplastic, and
the support and the sealing edge formed using injection molding.

12. The plug-type connection as claimed in claim 10, wherein the housing aperture is configured as a shaft, and the sealing edge is arranged radially on an outside of the support.

13. The plug-type connection as claimed in claim 10, wherein the sealing edge is arranged axially on a side of the support that faces away from the printed circuit board.

14. The plug-type connection as claimed in claim 10, wherein the housing aperture has a projection that faces the printed circuit board, and the support bears against the projection.

15. The plug-type connection as claimed in claim 10, wherein the support comprises a stop configured to bear against a side of the housing aperture that faces the printed circuit board.

16. The plug-type connection as claimed in claim 10, wherein the support is integrally produced with fixing pins configured to enter recesses in the printed circuit board.

17. The plug-type connection as claimed in claim 10, further comprising sealing compound configured to seal the contacts from the support.

18. The plug-type connection as claimed in claim 10, wherein the support further comprises tubular stubs that sheath the contacts.

19. The plug-type connection as claimed in claim 11, wherein the housing aperture is configured as a shaft, and the sealing edge is arranged radially on an outside of the support.

20. The plug-type connection as claimed in claim 11, wherein the housing aperture has a projection that faces the printed circuit board, and the support bears against the projection.

21. The plug-type connection as claimed in claim 20, wherein the support comprises a stop configured to bear against a side of the housing aperture that faces the printed circuit board.

22. The plug-type connection as claimed in claim 21, wherein the support is integrally produced with fixing pins configured to enter recesses in the printed circuit board.

23. The plug-type connection as claimed in claim 22, further comprising sealing compound configured to seal the contacts from the support.

24. The plug-type connection as claimed in claim 23, wherein the support further comprises tubular stubs that sheath the contacts.
